(19) United States
(12) Patent Application Publication
(10) Pub. No.: US 2026/0160675 A1
(43) Pub. Date: Jun. 11, 2026

(54) METHOD FOR SPECTROSCOPIC DETERMINATION AND APPLICATION OF THE METHOD

(71) Applicant: Endress+Hauser Optical Analysis, Inc., Ann Arbor, MI (US)

(72) Inventors: Jürgen Dessecker, Wittlingen (DE); Patrick Ehlers, Mölnlycke (SE); Florian Krogmann, Kreuzlingen (CH); Marc Winter, Saline, MI (US)

(21) Appl. No.: 19/414,829

(22) Filed: Dec. 10, 2025

(30) Foreign Application Priority Data
Dec. 10, 2024 (DE) 10 2024 136 958.2

(51) Int. Cl. G01N 21/27; G01J 3/28; G01J 3/44

(52) U.S. Cl. CPC G01N 21/274; G01J 3/44; G01J 2003/2873; G01J 2003/2879

(57) ABSTRACT

A method for spectroscopic determination of at least one measured variable in a medium includes defining an application; providing a spectrometer, providing a raw spectrum; applying a calibration to the raw spectrum to obtain a calibrated spectrum; standardizing the calibrated spectrum to obtain a standardized spectrum. The standardization is performed using spectrometer-type-specific information and a transformation function, wherein the transformation function comprises the calibrated spectrum and additional measurement information as input variables and comprises a spectrometer-specific transformation function and calibration features. The method further comprises selecting, adapting, and/or creating a spectrometer-independent and application-specific model from the standardized spectrum and application-specific data; and determining the at least one measured variable from the raw spectrum using the model.

### CROSS-REFERENCE TO RELATED APPLICATION

The present application is related to and claims the priority benefit of foreign patent application No. DE 10 2024 136 958.2, filed Dec. 10, 2024, the entire contents of which are incorporated herein by reference.

### TECHNICAL FIELD

The present disclosure relates to a method for the spectroscopic determination of at least one measured variable in a medium. The present disclosure also relates to an application of the method.

### BACKGROUND

In spectroscopy, the raw spectrum, i.e., the pure measured values, is mapped onto the measured variable by a “model”. For example, frequency-dependent effective cross-sections are mapped onto absolute concentrations of a specific substance in a medium. This applies to all spectroscopy methods, including Raman spectroscopy.

Such models are usually only valid for the device configuration with which the spectra were collected for training the model. As soon as one or more parts of the measuring devices are replaced, the model loses its validity and must be created anew, which often involves enormous experimental effort. The partial or complete repetition of the experiments for recording the training spectra requires a great amount of time and possibly high costs, e.g., in the biopharmaceutical sector, for the provision of the measurement medium in all variations required for model creation, as well as personnel resources of appropriately trained personnel and instrumentation. The creation of a new model requires highly qualified experts with domain knowledge of the measurement medium, the spectroscopy method, and the model creation itself.

### SUMMARY

The object of the present disclosure is to simplify model generation.

The object is achieved by a method for the spectroscopic determination of at least one measured variable in a medium, comprising the steps of: defining an application; providing a spectrometer; providing a raw spectrum, for example, by measuring the medium by means of the spectrometer; applying a calibration to the raw spectrum and obtaining a calibrated spectrum; standardizing the calibrated spectrum and obtaining a standardized spectrum, wherein the standardization is carried out by means of spectrometer-type-specific information and a transformation function, wherein the transformation function comprises the calibrated spectrum and additional information on the measurement as input variables, and comprises a spectrometer-specific transformation function and calibration features; selecting, if necessary adapting, or creating a spectrometer-independent and application-specific model from the standardized spectrum and application-specific data; and determining the measured variable(s) from the raw spectrum by means of the model.

The object is achieved by a method for the spectroscopic determination of at least one measured variable in a medium, comprising the steps of: defining an application; providing a spectrometer; providing a raw spectrum, for example, by measuring the medium by means of the spectrometer; applying a calibration to the raw spectrum and obtaining a calibrated spectrum; selecting, for example, adapting, or creating a spectrometer-type-specific and application-specific model from the calibrated spectrum, application-specific data and by means of at least one database, wherein the database comprises models for calibrated spectra and non-standardized spectra; and determining the measured variable from the raw spectrum by means of the model.

This generally simplifies model generation. For the user, the claimed method makes it possible to reduce costs and effort, and thus to make a spectroscopy method, which is actually very difficult to set up, such as Raman spectroscopy, accessible even to users who do not have sufficient resources to create models themselves.

The claimed present disclosure eliminates the need to retrain models for new instrument configurations or at least significantly reduces the experimental effort required for model transfer. Additionally, the effort for model adaptation (model structure, model weighting factors), for verification and validation of the model is reduced. In addition, time is saved because certification of the entire measurement is no longer necessary or is greatly simplified (for example, cGMP, i.e., the current Good Manufacturing Practice of the Food and Drug Administration (FDA)).

At least one embodiment provides that the raw spectrum is provided from a source other than the measurement by the spectrometer. In at least one embodiment, this is done from the literature or by means of another spectrometer (i.e., not the spectrometer used to measure the measured variable in the medium). For example, the other spectrometer is a spectrometer of the same type/model. In at least one embodiment, the other spectrometer is a different type/model, for example, from a different manufacturer.

Logically, every spectrometer always first ascertains a raw spectrum. However, calibration from the raw data is often already carried out in the spectrometer so that the user does not have direct access to the raw spectrum. In this case, processing begins directly with the calibrated spectrum. The same often applies to spectra from the literature.

In at least one embodiment, without an explicit calibration step, the raw spectrum output meets the stability criteria that are also required of the calibrated spectrum. In this case, the raw spectrum corresponds to the calibrated spectrum.

At least one embodiment provides that the application is the qualitative, or quantitative, determination of the composition of the medium, taking into account one or more substances to be determined, i.e., the measured variable(s). A specific example in this respect is the alcohol concentration in wine production, the glucose or lactate concentration in cell culture media, or amino acids in the production of pharmaceutical products. Further examples can be found downstream in pharmaceutical products in the processing of mAbs (monoclonal antibodies) or the separation of proteins and protein aggregates (high molecular weight species). Likewise, the determination of methane, CO₂, H₂O, H₂S in natural gas is possible.

At least one embodiment provides that the calibration includes the wavelength and/or the intensity. In Raman spectroscopy, for example, the Raman shift (usually in wavenumbers on the x-axis of the spectrum) and the intensity (usually in arbitrary units (au) on the y-axis) are plotted.

At least one embodiment provides that the calibration takes into account the measurement setup with the spectrometer and connected additional measuring equipment, for example, a measuring probe. A calibration that was determined for the measurement setup is thus applied to the raw spectrum. A calibrated spectrum is then obtained. For the calibration of the measurement setup, either the spectrometer can be considered on its own or additional measuring equipment can also be considered (e.g., the measuring probe, optionally also the process connection).

During the “standardization” of the calibrated spectrum, any remaining differences (between the spectrometers) after calibration are corrected. These differences may, for example, be systematic errors in the calibration, different resolutions (samples per wavenumber), different measurement ranges (e.g., for the Raman shift), different file formats of spectra from different device manufacturers, etc.

A standardized spectrum for an application ideally looks exactly the same, regardless of the measuring device used to record it. All residual variances then originate only from the application (except for residual errors from the standardization).

It is also possible to take statistical, non-systematic errors into account if the distribution is known. For this purpose, a set of standardized spectra is created from a single calibrated spectrum. The set of standardized spectra contains the expected variance due to the statistical dispersion around the assumed “true” spectrum. This set of standardized spectra is used in model training to make the model robust against the expected dispersions so that a correct measurement can be made despite the dispersion.

At least one embodiment provides that spectrometer-type-specific information includes information provided explicitly or derived from the spectrum, such as a reference spectrum, such as isopropanol, data sheet information, previous measurements, model, configuration, settings, etc.

The “spectrometer-specific transformation function” is a function that converts spectra from this device into standardized spectra, taking into account the “spectrometer-type-specific information”.

For unknown devices, the spectrometer-type-specific information would have to be comprehensive enough to create the transformation function. If a sufficiently generalized transformation function is known (for example, because the spectrometer and the application have been used in this combination multiple times), it can be configured and applied with less information.

At least one embodiment provides that, in addition to the transformation function, a distribution function is used, which comprises the distribution of the remaining residual errors of the calibration, wherein the standardized spectrum comprises a probability of dispersions around the calibrated spectrum. The distribution function describes the distribution of the remaining residual errors of the calibration. In this case, the standardized spectrum is not a spectrum, but a statistically described probability of dispersions around the “true” calibrated spectrum. This dispersion may then also be part of the standardized spectrum or the associated set of spectra.

At least one embodiment provides that the transformation function is taken from a transformation function database, wherein the transformation function database is formed from already existing transformation functions.

At least one embodiment provides that the application-specific data include information on the application, for example, the expected composition of the medium and of the measured variable(s), the temperature, the pressure and/or a background matrix of the substances not to be determined. In at least one embodiment, the application-specific data comprise a small number of spectra from measurements with known concentrations, which are used to automatically adapt the model (e.g., a zero measurement, span 0% and 100%, etc.).

At least one embodiment provides that new or adapted models are stored in a database, for example, for models from standardized spectra, non-standardized and/or calibrated spectra, and/or wherein the models are loaded from a database.

At least one embodiment provides for standardized models to be converted into calibrated models, and vice versa.

At least one embodiment provides that more than one model is used. In most cases, it will be only one model. If multiple models are used to compare the results as a “joint” analysis, possibly taking a quality metric into account, the best/most reliable result can be selected or there is the possibility of combining the different results.

At least one embodiment provides for a reliability value to be calculated and displayed for the model. The same or a similar metric as used to determine how well a model fits is used for this purpose. In at least one embodiment, the concentration can be used at model level. If this concentration is within an acceptable range, the reliability is good enough for this application. The measurement error of the concentration determination can be used.

The object is further achieved by applying a method as described above with a Raman spectrometer.

### BRIEF DESCRIPTION OF DRAWINGS

This is explained in more detail with reference to the following figures.

FIG. 1 shows the claimed method.

FIG. 2 shows embodiments of some method steps of the claimed method.

FIG. 3 shows the standardization symbolically.

### DETAILED DESCRIPTION

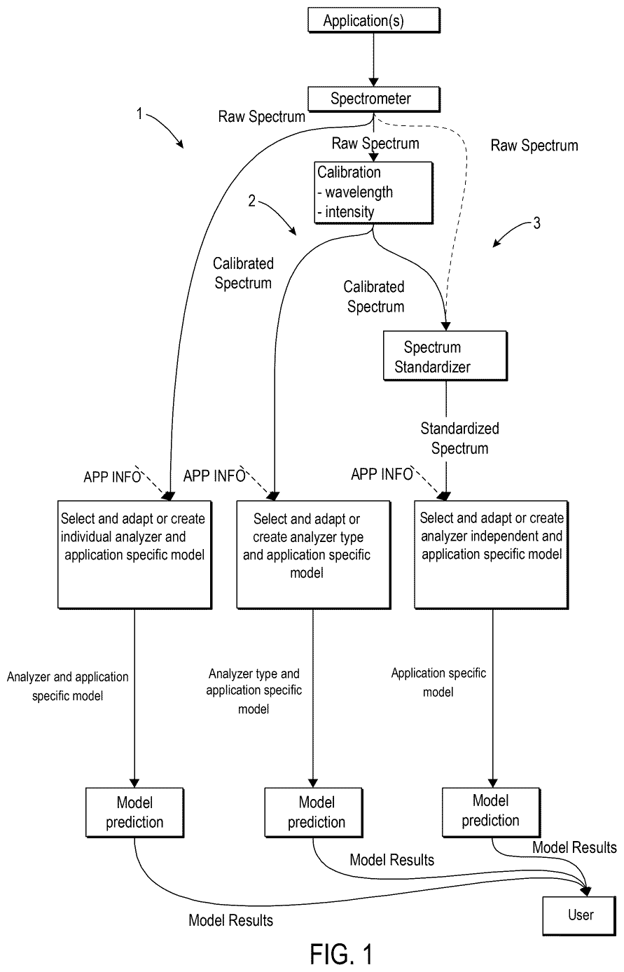

FIG. 1 shows the claimed method. Based on an application, a spectrometer, for example a Raman spectrometer, is selected. The spectrometer is used for the spectroscopic determination of at least one measured variable in a medium.

A spectrograph is an optical instrument that disperses light of different wavelengths into its spectrum and records the resulting spectrum by means of suitable detectors. Instruments for spectroscopy, the visual observation of spectra, are called spectroscopes. A spectrometer is a device for representing a spectrum. Unlike a spectroscope, it offers the possibility of measuring the spectra. In the context of this document, “spectrometer” refers to the entire device that ultimately outputs the measured variable(s) from a spectrum as concentration value(s) via the model(s).

The spectrometer thus creates the raw spectrum of the medium. In some cases, the raw spectrum may not be available to the user, but is only used for further calculations. A calibration is usually applied thereto (see below), and only this is shown to the user.

There are three possibilities, which are denoted by reference signs 1, 2, and 3.

In all variants, more than one spectrum is usually used. Through experimental design and execution of the experiment, a set of spectra is created, which represents the best possible compromise between effort and coverage of all relevant variances from the expected measurement. For the sake of simplicity, “the spectrum” is referred to below, but this always means multiple spectra unless otherwise stated.

In the left path, which is denoted by reference sign 1, a model for the individual spectrometer and the individual application is created from the spectrum. If this has already been done, the model is selected. This results in a model for precisely this one spectrometer and for precisely this one application. The model provides the user with the measured values of the measured variable.

In the middle path, which is denoted by reference sign 2, the raw spectrum is first calibrated. In at least one embodiment, this is done via the wavelength and the intensity. A model that is suitable for a specific spectrometer type and a specific application is created from this calibrated spectrum. If exactly this configuration already exists, the model is selected. If only small details are different, the model is adapted. A corresponding database is also used in this process (see below).

The adaptation of the model can be device-related, for example replacing a component with an identical component (e.g., replacing a probe with an identical probe).

The adaptation of the model can be process-related, for example through a very similar application (e.g., a changed composition of the nutrient solution in bioprocesses with essentially the same measurement task or the same measurement task with slightly changed process control and a corresponding variance in the spectra, which was previously not covered by the model's training dataset).

The adaptation of the model can comprise the environmental parameters, for example the application in a different factory, experimenter, different ambient air pressure/temperature, etc.

The adaptation of the model can be determined by means of the measured variables; for example, there is already a model for two measured variables, but the user wants three, wherein two of them are the same as in the original model.

This results in a spectrometer-type-specific and application-specific model from which the measured variable is determined.

The third path 3 is described below. This path allows for the best possible and easiest handling of the spectrometer. The idea is that the user only specifies what is to be measured. The method allows for the measurement to be carried out with reduced effort, whether for purely technical reasons and/or for certificates/audits.

First, the raw spectrum is calibrated as described above. Then, the calibrated spectrum is standardized. This is described below.

In the dashed path from the spectrometer to the standardizer, the raw spectrum without an explicit calibration step meets the stability criteria that are also required of the calibrated spectrum. In this case, the raw spectrum corresponds to the calibrated spectrum, which is then standardized.

Finally, the model is created anew, selected, or adapted from the standardized spectrum, depending on the initial situation. The result is a model that is only application-specific but independent of the spectrometer type.

During the “standardization” of the calibrated spectrum, any remaining differences (between the spectrometers) after calibration are corrected. These differences may, for example, be systematic errors in the calibration, different resolutions (samples per wavenumber), different measurement ranges (e.g., for the Raman shift), different file formats of spectra from different device manufacturers, etc.

A standardized spectrum for an application ideally looks exactly the same, regardless of the spectrometer type used to record it. All residual variances then only originate from the application, the influence of which, if standardization is successful, is small in comparison to the acceptable measurement error.

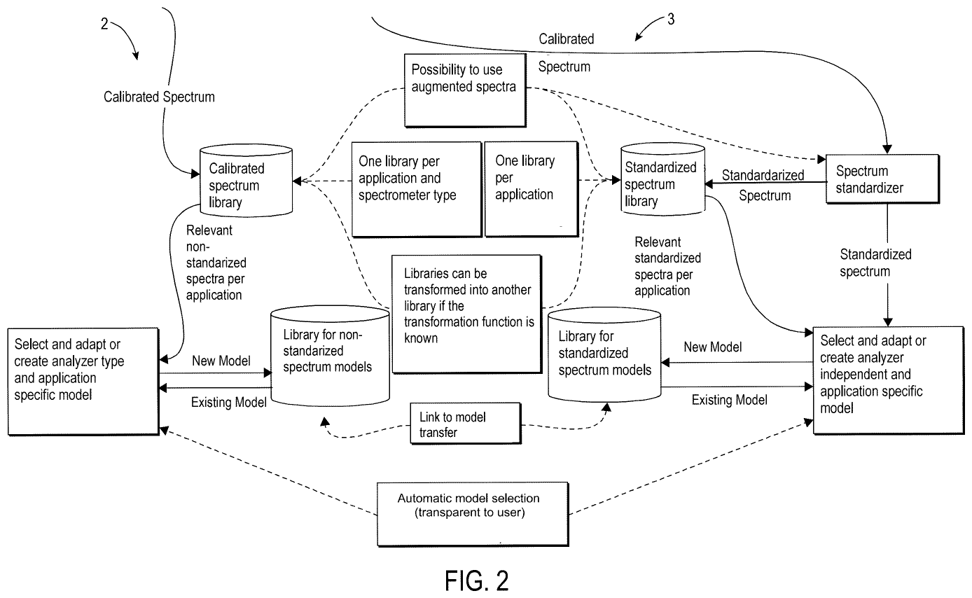

FIG. 2 shows embodiments of various method steps. FIG. 2 is based on a calibrated spectrum. It can be seen that there is a database for both the calibrated spectrum and the standardized spectrum, e.g., for path 2 and for path 3 (see FIG. 1). Each of these is referred to as a “library”. Depending on the type of spectrum, there is one database per application and spectrometer type or one database per application. The databases can be converted into each other if the spectrometer-type-specific transformation function is known. If the transformation function is known, the conversion of calibrated to standardized spectra is possible directly. The reverse path from standardized to merely calibrated spectra is only possible (without losses) if the transformation function is uniquely invertible, taking into account all meta-information on the particular spectrum.

“Meta-information” includes, for example, the analyte(s), background matrix, application, exposure time, integration time, temperature, pressure, hardware, manufacturer information, etc.

It is also possible to use artificial spectra in each case. These can either be completely synthetically created spectra or modified, real spectra, so-called augmented spectra. An example in this respect is the aforementioned set of standardized spectra (e.g., for taking into account statistical, non-systematic errors). This set contains the expected variance due to the statistical dispersion around the assumed “true” spectrum.

Data, e.g., spectra, from the databases can be used for the model. The spectra are selected from the database such that they allow a sufficiently good model selection, modification or creation for the measurement task, with or without additional measurement spectra.

There are databases for calibrated spectra and standardized spectra.

There are also databases for the models, i.e., at least one database for models with non-standardized spectra and one database for models with standardized spectra. There are one or more models for path 2 and for path 3, see FIG. 2. Transformation between the models is possible. A new model can be loaded into the database, while an existing model can be taken from the database. Without such a database, new training data (spectra) would have to be generated for each application. If the model already exists, it can simply be selected or optionally adapted for better performance. If the model does not exist, it is created anew. The new model may be created based on existing models that are close to the model to be created. Thus, spectra are either taken from a database in order to reduce the effort required to provide spectra for model selection/adaptation/creation. Alternatively, one or more models are taken from a database in order to reduce the effort involved in model adaptation or model creation.

In at least one embodiment, new or adapted models are loaded into the database.

It is true that models for non-standardized spectra are usually not transferable to other spectrometer types with acceptable accuracy.

Ideally, the selection of the model is automatic and transparent to the user. This makes it as easy as possible for users to achieve acceptable measurement results. In addition to the automated model selection mentioned above, for further simplification, databases with models can be supplied with the device or made available in the cloud/at a central location, for example in a manner retrievable by the device.

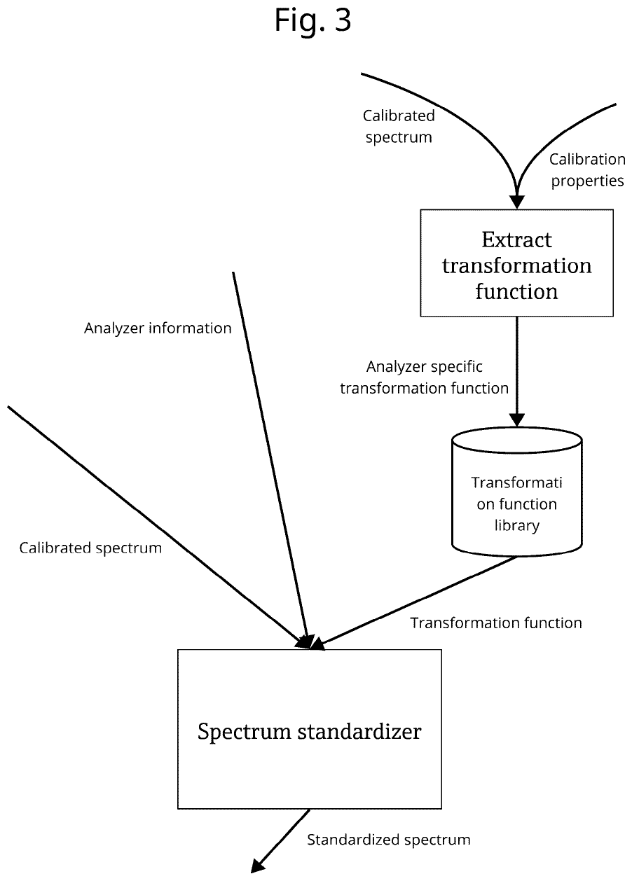

FIG. 3 shows the standardization symbolically. Standardization is carried out by a “spectrum standardizer”.

With a perfect calibration, standardization is only required to standardize the resolution of the x-axis and/or y-axis. However, in most cases, standardization is additionally required to compensate for a residual error remaining in calibrated spectra.

If the calibrated spectrum already meets the requirements for a standardized spectrum, the standardization step can simply consist of passing on the data. Only meta-information may then be added.

After calibration, the following imperfections and variations may exist: calibration tolerance, resolution, range, or SNR. However, the standardizer cannot add missing information. A standardized spectrum cannot be better than the calibrated spectrum (unless there is additional information about the device) and can only make spectra equally “bad”, but not better. Noise can only be removed to a limited extent. The information content of the spectra that is relevant to the evaluation in the model and the calculation of the measurement results must not be negatively influenced by the noise suppression. The resolution, however, can be adjusted if the measurement was not subsampled. The measurement range can be reduced. Systematic and known calibration errors can be compensated.

In at least one embodiment, the standardizer is supplied with the model. In the best case, the user does not notice that the model pre-standardizes the spectra, but the model automatically becomes more robust and more generic.

There may be one or more standardizers per spectrometer.

A standardized spectrum can be transferred by means of “inverse standardization” from a first analyzer to a second analyzer, and vice versa. For this purpose, the standardized spectrum, which was originally measured with a first spectrometer type, is converted by means of the inverse standardization function of a second spectrometer type into the format that corresponds to a calibrated spectrum of the second spectrometer type. This means that models that were originally created for calibrated spectra of the second spectrometer type can also be used for spectra of the first spectrometer type. The reverse route, from the second to the first, is also possible. In both cases, the invertibility of the transformation function must be given.

The standardizer receives the calibrated spectrum, spectrometer-type-specific information and a transformation function as input value. The output value is the standardized spectrum.

The spectrometer-type-specific information consists of information, provided explicitly or derived from the spectrum, about the spectrometer type, e.g., a reference spectrum, data sheet information, separate measurements, etc.

For the transformation function, there may also be a database (“library”) with already existing transformation functions.

The transformation function is formed from the calibrated spectrum and calibration features. The transformation function is extracted therefrom, resulting in the spectrometer-type-specific transformation function.

1. A method for the spectroscopic determination of at least one measured variable in a medium, comprising the steps of:
defining an application;
providing a spectrometer;
obtaining a raw spectrum;
applying a calibration to the raw spectrum to obtain a calibrated spectrum;
standardizing the calibrated spectrum to obtain a standardized spectrum,
wherein standardization is performed using spectrometer-type-specific information and a transformation function,
wherein the transformation function uses the calibrated spectrum and additional measurement information as input variables and comprises a spectrometer-specific transformation function and calibration features;
selecting, adapting, and/or creating a spectrometer-independent application-specific model from the standardized spectrum and application-specific data; and
determining the at least one measured variable from the raw spectrum using the model.

2. The method according to claim 1,
wherein the step of obtaining the raw spectrum comprises measuring the medium using the spectrometer.

3. The method according to claim 1,
wherein the calibration comprises wavelength and/or intensity.

4. The method according to claim 1,
wherein the calibration accounts for a measurement setup comprising the spectrometer and connected additional measuring equipment.

5. The method according to claim 4,
wherein the connected additional equipment comprises a measuring probe.

6. The method according to claim 1,
wherein the application comprises the qualitative or quantitative determination of the composition of the medium, accounting for one or more substances to be determined as the at least one measured variable.

7. The method according to claim 1,
wherein, in addition to the transformation function, a distribution function is used that includes the distribution of remaining residual calibration errors, and wherein the standardized spectrum comprises a probability of dispersions around the calibrated spectrum.

8. The method according to claim 1,
wherein the transformation function is configurable and features of the standardized spectrum are adjustable.

9. The method according to claim 8,
wherein the wavenumber range and the resolution of the initial spectrum are adjustable.

10. The method according to claim 1,
wherein the transformation function is retrieved from a transformation function database, and wherein the transformation function database is formed from existing transformation functions, and/or
wherein a changed transformation function is stored in the transformation function database.

11. The method according to claim 1,
wherein the application-specific data comprises information related to the application.

12. The method according to claim 11,
wherein the application-specific data comprises at least one of: expected composition of the medium, the at least one measured variable, temperature, and pressure.

13. The method according to claim 1,
wherein a reliability value is calculated and displayed for the model.

14. An application of the method according to claim 1 using a Raman spectrometer.

15. A method for the spectroscopic determination of at least one measured variable in a medium, comprising the steps of:
defining an application;
providing a spectrometer;
providing a raw spectrum;
applying a calibration to the raw spectrum to obtain a calibrated spectrum;
selecting, adapting, and/or creating a spectrometer-type-specific application-specific model from the calibrated spectrum and application-specific data using at least one database, wherein the database comprises models for calibrated spectra and non-standardized spectra; and
determining the at least one measured variable from the raw spectrum using the model.

16. The method according to claim 15,
wherein the spectrometer-type-specific information comprises information provided explicitly or derived from the spectrum.

17. The method according to claim 16,
wherein the spectrometer-type-specific information includes at least one of: a reference spectrum, data sheet information, previous measurements, configuration, settings, known and/or systematic calibration errors that can be compensated in the calibrated spectrum, temperature dependences, spectral artifacts, electronics and signal processing in the spectrometer.

18. The method according to claim 17,
wherein the reference spectrum comprises spectral features of isopropyl alcohol, the data sheet information comprises resolution and measurement range in wavenumbers, the known and/or systematic calibration errors result from nonlinearities of wavelength axis or intensity calculation, and/or the artifacts originate from optical elements in the device, probe, or process connection.

19. The method according to claim 15,
wherein new or adapted models are stored and/or retrieved from a database.
